(19) United States
(12) Patent Application Publication
(10) Pub. No.: US 2004/0082676 A1
(43) Pub. Date: Apr. 29, 2004

(54) Method for mixing blowing agents with polyurethane reagents for the production of polyurethane foam boards

(76) Inventors: Bruce F. Douglas, Zionsville, IN (US); John B. Letts, Carmel, IN (US)

Correspondence Address: Bridgestone Americas Holding Inc, Chief Intellectual Property Counsel, 1200 Firestone Parkway, Akron, OH, 44317-0001, US

(21) Appl. No.: 10/468,487

(22) PCT Filed: Mar. 7, 2002
(86) PCT No.: PCT/US02/06823

(51) Int. Cl. C08G 18/00

(52) U.S. Cl. 521/155

(57) ABSTRACT

A method for manufacturing polyurethane and polyisocyanurate foams comprising the steps of charging at least one blowing agent and a polyol component to an in-line continuous mixer, wherein the at least one blowing agent and the polyol component are continuously charged in separate streams advanced at predetermined flow rates chosen to bring about a desired ratio of blowing agent to polyol component within the in-line continuous mixer.

### BACKGROUND OF THE INVENTION

This invention relates to a process and apparatus for producing rigid foams, particularly polyurethane or polyisocyanurate foam boards having cell structures that are formed by the expansion of polyurethane reagents. Such rigid foam boards are often used as thermal insulators in construction.

Rigid foams based on polyurethane or polyisocyanurate are known and are typically produced by the reaction of an isocyanate with an isocyanate-reactive component (polyol component), which reaction is expanded with a blowing agent to provide a foam. The isocyanate, polyol, and blowing agent, together with catalysts and other optional components, are all brought into contact at a dispensing head that dispenses the foam formulation onto a laminator. The blowing agent is typically dissolved or emulsified in the polyol component and, during the exothermal reaction between the polyol and isocyanate compounds, volatizes at or above its boiling point to produce the pore or cellular structure of the foam. The isocyanate is provided in what is termed an “A-side” stream of reagents, while the polyol component is provided in a “B-side” stream of reagents.

Foam operations typically have a low-pressure side and a high-pressure side. The transportation of the various chemical reagents of the B-side from one area to another typically occurs on the low-pressure side. Mixing of the B-side components, including blowing agents, may also occur in these areas. Typically, on the low-pressure side, mixing blades are used to mix the chemicals in a large batch.

Due to governmental demands regarding the industrial output of ozone- depleting compounds, foam boards are now produced using various pentane isomers as blowing agents. Pentane isomers are normal pentane, isopentane, and cyclopentane. Normal pentane and isopentane are the least expensive of the isomers, but they are also the least soluble in the reagents used to make polyurethane foams. Cyclopentane is relatively soluble in most polyurethane reagents, and also exhibits good initial thermal performance; however, it is expensive and boards produced with it demonstrate poor dimensional stability in colder environments. Additionally, cyclopentane may contain 2,2-dimethylbutane as a byproduct, and this byproduct is more likely to phase separate in the B-side stream. Blends of these various pentane isomers often are used.

One method used to dissolve pentane isomer blends into polyurethane reagents includes the use of surfactants, emulsifiers, and/or solubilizers in the B-side of the foam formulation. The A-side of the foam formulation is added after allowing the pentane isomers within the B-side to become adequately dissolved or emulsified therein. To form the B-side the blowing agents are bubbled through and/or mechanically mixed in a large tank containing the polyol component and, optionally, other components such as catalysts, surfactants, and flame-retardants. Thus, the volume of blowing agent present within the B-side at any given time is quite large. Additionally, although surfactants, emulsifiers, and solubilizers may help counter-phase separation, they tend to increase the cost of foam board production, and their presence can affect board performance as well.

In one alternative, pentane isomers are mixed into the polyol of the foam formulation, via proprietary technology, at low-pressure, and are retained within a tank from which the mixture is then drawn and fed to high-pressure pumps that bring the mixture into contact with the A-side stream to produce the foam board.

In both of the aforementioned methods, a substantial amount of pentanes are present in a substantial volume of the B-side. Blowing agents such as pentanes are flammable and therefore the presence of a large amount of pentanes dissolved or emulsified in the B-side is a safety concern. Also, these methods are inefficient in cases where the pentane isomers tend to quickly phase separate from the other components within the B-side stream. This phase separation negatively impacts the properties of the foam board being produced, because the expansion of the board, via the pentane isomers, is less efficient.

In another alternative, the B-side stream does not contain pentane isomers, rather, the pentanes are added as a third stream to the B-side stream, at high-pressure, just before impingement with the isocyanate, i.e., the A-side stream. In this high-pressure mixing method, it is difficult to size a static mixer to effectively mix the A-side, B-side, and pentane isomers at the various output rates that may be required for boards of different thicknesses and different production rate. If the static mixer is too small, backpressure within the system will undesirably increase and the components may not be completely mixed. If the static mixer is sized too large, the mixing efficiency will decrease for low-output formulations. Static mixers of different sizes may be employed, but this is not cost effective.

Additionally, when pentane isomers such as n-pentane or isopentane are employed as the blowing agents, prior art processes may require surfactants in an amount from about 0.5 to about 5.0 pphp and emulsifiers/solubilizers in an amount from about 0 to about 30 pphp. As mentioned surfactants, solubilizers, and emulsifiers tend to plasticize the foam produced and, therefore, reduced amounts of these components in the foam formulation is desirable.

Thus, a method for mixing pentane isomers with polyurethane reagents for the production of foam boards that allows for wide flexibility in the ratios and amounts of pentane isomers that may be used and allows for a reduction in the amount of flammable pentane blowing agents present within a B-side stream at any given time is desirable. While the need particularly addressed by the process and apparatus of the present invention concerns the incorporation of pentane isomers into the polyol components, it should be appreciated that the present invention allows for the incorporation of blowing agents, other than pentane isomers, into the polyol component.

Generally, high-pressure mixing of the A- and B-sides will produce fine cell foam more efficiently and with better physical properties than low-pressure mixing of the A- and B-sides. Thus, the present invention focuses on the low-pressure mixing of blowing agents to form the B-side stream, while maintaining the high-pressure mixing of the A- and B-side streams.

### SUMMARY OF THE INVENTION

A method for manufacturing polyurethane and polyisocyanurate foams comprising the steps of charging at least one blowing agent and a polyol component to an in-line continuous mixer, wherein the at least one blowing agent and the polyol component are continuously charged in separate streams advanced at predetermined flow rates chosen to bring about a desired ratio of blowing agent to polyol component within the in-line continuous mixer.

A method for manufacturing polyurethane and polyisocyanurate foams comprising the steps of charging at least one blowing agent and a polyol component to an in-line continuous mixer, at a pressure of less than about 3,400 kPa, to form a B-side stream of polyurethane reagents contacting the B-side stream of polyurethane reagents with an isocyanate component at a dispensing head to provide a foam formulation, and dispensing the foam formulation from the dispensing head, wherein the residence time of the B-side stream of polyurethane reagents, from its exit from the in-line continuous mixer to its exit from the dispensing head as part of the foam formulation, is less than about 5 minutes.

A method for manufacturing polyurethane and polyisocyanurate foams comprising the steps of charging at least one blowing agent and a polyol component to an in-line continuous mixer at a pressure of less than about 3,400 kPa, wherein the at least one blowing agent and the polyol component are continuously charged in separate streams advanced at predetermined flow rates chosen to bring about a desired ratio of blowing agent to polyol component within the in-line continuous mixer, mixing the at least one blowing agent and the polyol component in the in-line continuous mixer to dissolve or emulsify the blowing agent in the polyol component and thereby provide a B-side stream of polyurethane reagents, contacting the B-side stream of polyurethane reagents with an isocyanate component at a dispensing head to provide a foam formulation, and dispensing the foam formulation from the dispensing head, wherein the residence time of the B-side stream of polyurethane reagents, from its exit from the in-line continuous mixer to its exit from the dispensing head as part of the foam formulation, is less than about 5 minutes.

The in-line continuous mixer may be a static or dynamic mixer and, in a preferred embodiment, the step of mixing the at least one blowing agent with the polyol component is carried out in an in-line dynamic mixer. The step of mixing the polyol and blowing agent may also be carried out in more than one in-line continuous mixer, with one or more in-line dynamic mixer, and/or one or more in-line static mixer.

In preferred embodiments, at least one pentane isomer serves as the blowing agent for the foam manufacturing process. While the apparatus and method of the present invention may be employed using any suitable blowing agent, advantages of the present apparatus and method are particularly realized when blowing agents such as pentane isomers are employed because pentane blowing agents are not very soluble in the polyol and isocyanate components used to produce foam boards and, thus, they tend to phase separate from these components. The present invention more adequately mixes the blowing agents, particularly pentane blowing agents, with the polyol and isocyanate components to ensure efficient expansion of the foam board. Also, the fact that an in-line continuous mixer is employed at low-pressure allows for flexibility in the ratios and amounts of the various blowing agents that can be used and incorporated into the polyol mixture stream. Additionally, mixing in an in-line continuous mixer may reduce the need for the use of solubilizers or emulsifiers or surfactants that negatively impact end product performance and increase manufacturing costs. The present invention may also reduce—by about 5%—the amount of blowing agents necessary to produce a polyurethane foam of a desired density. The in-line continuous mixing of the at least one pentane isomer, at low-pressure, also results in smaller cells within the polyurethane or polyisocyanurate foam, thereby yielding foam having better insulation properties.

The present invention also provides an apparatus for manufacturing polyurethane and polyisocyanurate foams that employ flammable blowing agents. The apparatus includes an in-line continuous mixer having a volume in the range of from about 1 liter to about 40 liters. A ventilation system encloses the in-line continuous mixer to collect any flammable blowing agents that may escape the in-line continuous mixer during operation thereof. Notably, the volume of the in-line continuous mixer is smaller that the volume of prior art devices utilized to incorporate blowing agents into the foam formulation. Therefore, the ventilation system is also smaller, less costly, and easier to maintain. Also, should an accident occur that would ignite the flammable blowing agents, the small size of these elements of the apparatus help to minimize the damage that could occur.

### BRIEF DESCRIPTION OF THE DRAWINGS

FIG. 1 is a chart depicting a preferred process according to the present invention.

FIG. 2 is a particular embodiment of an in-line continuous mixer for use in accordance with the present invention.

### DETAILED DESCRIPTION OF ILLUSTRATIVE EMBODIMENTS

Polyurethane and polyisocyanurate foams are produced in a continuous manufacturing process by contacting an “isocyanate component” with a “polyol component.” The “isocyanate component” generally includes an isocyanate or polyurethane prepolymer. “Polyol component” generally includes a polyol and/or glycol, and, usually, small amounts of water, but “polyol component” refers to any isocyanate-reactive component as generally known in the art, including, for example, noon-limiting example, diols, glycols, polyols, water, and primary and secondary amines. A blowing agent is typically dissolved in or emulsified in the polyol component. The isocyanate and polyol components are contacted and dispensed onto a moving form, where they react and produce heat. The evolving heat and the chemical reactions taking place serve to bring about the foaming of the board. Particularly, the heat causes the blowing agents, such as pentanes, which are added as liquids, to volatize and evolve gas that becomes suspended in the reaction mixture to produce a foam. Water, added purposefully or as part of the polyol component, reacts with isocyanate to evolve carbon dioxide (CO2), which is also suspended in the reaction mixture to produce a foam.

Suitable isocyanates are generally known in the art. Useful isocyanates include aromatic polyisocyanates such as diphenyl methane, diisocyanate in the form of its 2,4′-, 2,2′-, and 4,4′-isomers and mixtures thereof, the mixtures of diphenyl methane diisocyanates (MDI) and oligomers thereof known in the art as “crude” or polymeric MDI having an isocyanate functionality of greater than 2, toluene diisocyanate in the form of its 2,4′ and 2,6′-isomers and mixtures thereof, 1,5-naphthalene diisocyanate, and 1,4′diisocyanatobenzene. Preferred isocyanate components include polymeric Rubinate 1850 (Huntsmen Polyurethanes), polymeric Mondur 489N (Bayer), and Lupranate M7OR (BASF).

Suitable polyol components are well known in the art. The terms “polyol component” or “polyol components” include diols, polyols, and glycols, which may contain water as generally known in the art. As mentioned, primary and secondary amines may be suitable “polyol components. Examples of polyols include polyether polyols and polyester polyols. Useful polyester polyols include phthalic anhydride based PS-2352 (Stepen), phthalic anhydride based polyol PS-2412 (Stepen), and teraphthalic based polyol 3522 (Kosa). Useful polyether polyols include those based on sucrose, glycerin, and toluene diamine. Examples of glycols include diethylene glycol, dipropylene glycol, and ethylene glycol. Of these, a particularly preferred glycol is diethylene glycol. Suitable primary and secondary amines include, without limitation, ethylene diamine, and diethanolamine.

Suitable blowing agents are also well known in the art. Fully halogenated chlorofluorocarbons, particularly trichlorofluoromethane (CFC-11), have been widely used as blowing agents. However, CFC's are believed to cause depletion of ozone in the atmosphere and are, therefore, currently being replaced by blowing agents having zero ozone depletion potential. These blowing agents include alkanes and cycloalkanes such as n-pentane, isopentane, cyclopentane, and mixtures thereof. Pentane isomers are particularly desirable blowing agents because they meet government mandates for the use of blowing agents having zero ozone depletion potential. Another alkane that meets government standards for its zero ozone depletion potential includes isobutane, and small amounts of isobutane may be employed as a blowing agent according to this invention.

As mentioned, particular advantages are realized when at least one pentane isomer is employed as a blowing agent in the present invention. A mixture of pentane isomers and other blowing agents may be employed. Thus, the present method allows for the addition of auxiliary blowing agents and gases. “Auxiliary blowing agents” as used herein include blowing agents and gases other than pentane isomers that may be used in a foam formulation. Other gases that could be added include nitrogen, air, carbon dioxide, and the noble gases. Notably, the present invention also allows for the addition of liquid carbon dioxide, which could eliminate the need for added water in the foam formulation. This addition could decrease the cost of foam production by at least about 1%. Also, the carbon dioxide, when it exits the mix head, as will later be described, will tend to froth the material and yield smaller cells, less splashing, and better distribution of the foam at the laminator. U.S. Pat. Nos. 5,367,000, 5,444,101, and 5,866,626 are incorporated herein by reference for the purpose of disclosing various useful pentane isomer blowing agent mixtures.

Catalysts are employed to initiate the polymerization reaction of the isocyanate component with the polyol component. Suitable catalysts are known in the art. Examples include salts of alkali metals of carboxylic acids and phenols, such as, for example potassium octoate; mononuclear or polynuclear Mannich bases of condensable phenols, oxo-compounds, and secondary amines, which are optionally substituted with alkyl groups, aryl groups, or aralkyl groups; tertiary amines, such as pentamethyladiethylene triamine (PMDETA), triethyl amine, tributyl amine, N-methyl morpholine, and N-ethyl morpholine; basic nitrogen compounds, such as tetra alkyl ammonium hydroxides, alkali metal hydroxides, alkali metal phenolates, and alkali metal acholates; and organic metal compounds, such as tin(II)-salts of carboxylic acids, tin(IV)-compounds, and organo lead compounds, such as lead naphthenate and lead octoate.

Surfactants, emulsifiers, and/or solubilizers may also be employed in the production of polyurethane and polyisocyanurate foams in order to increase the compatibility of the blowing agents with the isocyanate and polyol components. Suitable surfactants are known in the art.

Surfactants serve two purposes. First, they help to emulsify/solubilize all the components so that they react completely. Second, they promote cell nucleation and cell stabilization. Typically, the surfactants are silicone co-polymers or organic polymers bonded to a silicone polymer. Although surfactants can serve both functions, a more cost effective method to ensure emulsification/solubilization is to use enough emulsifiers/solubilizers to maintain emulsification/solubilization and a minimal amount of the surfactant to obtain good cell nudeation and cell stabilization. Examples of surfactants include Pelron surfactant 9868, Goldschmidt surfactant B8469, and CK-Witco's L 6912. U.S. Pat. Nos. 5,686,499 and 5,837,742 are incorporated herein by reference to show various useful surfactants.

Suitable emulsifiers/solubilizers are known in the art. Examples of emulsifiers for use in the present invention include DABCO Kitane 20AS (Air Products), and Tergitol NP-9 (nonylphenol+9 moles ethylene oxide).

Flame Retardants are commonly used in the production of polyurethane and polyisocyanurate foams, especially when the foams contain flammable blowing agents such as pentane isomers. Useful flame retardants are known in the art, Examples of flame retardants include tri(monochloropropyl) phosphate, tri-2-chloroethyl phosphate, phosphonic acid, methyl ester, dimethyl ester, and diethyl ester. U.S. Pat. No. 5,182,309 is incorporated herein by reference to show useful blowing agents.

As is generally known in the art, other additives may be employed in the production of polyurethane and polyisocyanurate foams. Other additives include, for example, dyes, fillers, fungicides, and anti-static substances.

The blowing agent preferably is mixed well with the other polyurethane reagents. A good mix ensures an adequate and efficient expansion (foaming) and is more likely to produce a foam that exhibits fine cell structure, good thermal performance, and satisfactory dimensional stability. Preferably, the blowing agents are solubilized or emulsified in the polyurethane reagents.

The isocyanate component and the polyol component are maintained as separate component streams until being brought together at a dispensing head where they are mixed and dispensed into a moving form. They then react and expand to produce a continuous foam product within this form. The isocyanate component is provided in an “A-side” stream. The A-side stream typically only contains the isocyanate component, but, in addition to isocyanate components, the A-side stream may contain flame-retardants, surfactants, blowing agents and other non-isocyanate-reactive components. The polyol component is provided in a “B-side” stream, which may additionally contain other isocyanate reactive compounds (such as water), flame retardants, catalysts, emulsifiers/solubilizers, surfactants, blowing agents, and other ingredients as mentioned above.

“Polyol mixture” refers to a mixture containing at least a polyol component and, optionally, any desired catalyst, surfactant, emulsifier/solubilizer, flame retardant, blowing agent, fillers, fungicides and anti-static substances. “B-side stream of polyurethane reagents” or simply “B-side” refers to a mixture of the polyol mixture and the blowing agents desired for production of the foam. Thus, the “polyol mixture” is mixed with blowing agent to form the “B-side,” and the polyol mixture will generally not contain blowing agent. Rather, the B-side stream that results from mixing blowing agent with the polyol mixture will contain the desired blowing agents.

“A-side stream of polyurethane reagents” or simply “A-side” refers to a mixture of at least an isocyanate component and, optionally, flame-retardants, surfactants, blowing agents, and other non-isocyanate-reactive components. The term “A-side” includes a prepolymer of isocyanate and polyol components as is known in the art.

The present invention focuses on the manner in which blowing agents are incorporated into the B-side stream and the manner in which the resultant B-side stream is subsequently brought into contact with the A-side stream and dispensed to produce a foam product. A polyol mixture is provided and mixed with desired blowing agents in an in-line continuous mixer to form a B-side stream of polyurethane reagents. This B-side stream is subsequently mixed with the A-side stream of polyurethane reagents to form a polyurethane or polyisocyanurate foam. More particularly, the blowing agents are added to the polyol mixture at low-pressure, and the resultant B-side stream of polyurethane reagents is subsequently advanced, at high-pressure, to contact the A-side stream proximate a dispensing head. Typically, the A-side and B-side streams are mixed and dispensed onto a moving bottom facing sheet that carries the resultant mixture into a restraint rise or free rise laminator in which the mixture reacts and expands to provide the desired foam, although they may be dispensed in another manner for different applications. Notably, the B-side is mixed with the A-side and dispensed into the laminator within about 1.5 minutes from the time when the B-side exits the in-line continuous mixer.

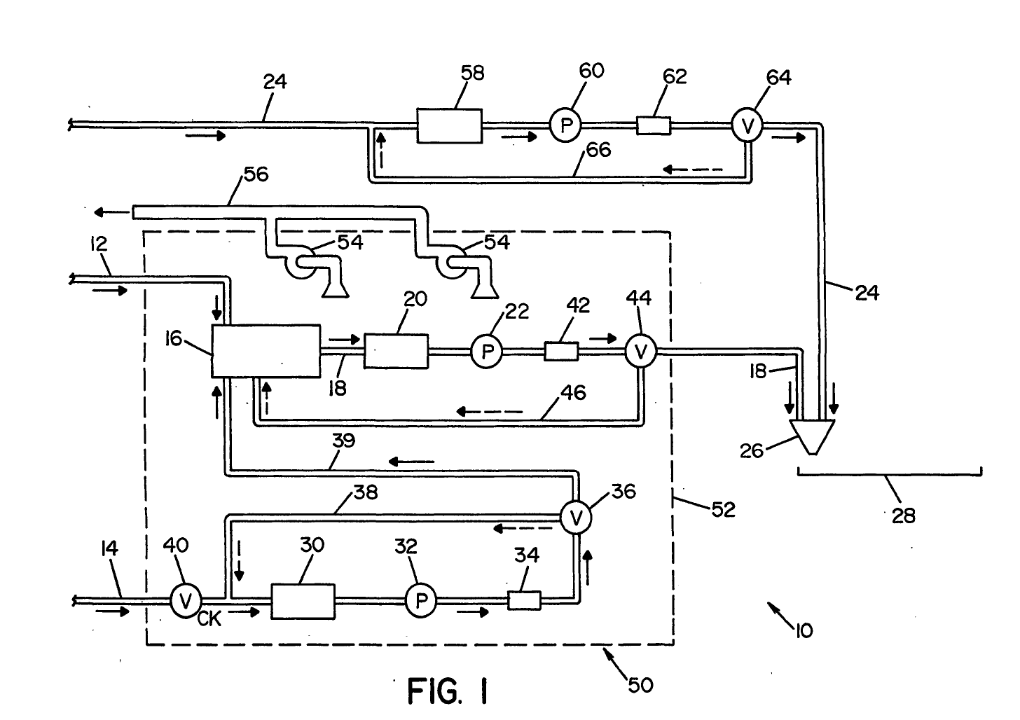

This process is represented in FIG. 1 by the schematic generally designated by the numeral 10. The various arrows represent streams of reagents flowing through pipes in a foam forming apparatus. The reagents within the process are identified hereinbelow with reference to the numerals drawn to those arrows.

As shown in FIG. 1, the polyol mixture 12 is contacted with blowing agent 14 in an in-line continuous mixer 16 that serves to dissolve or emulsify blowing agent 14 within polyol mixture 12 and thereby form a B-side stream 18 of polyurethane reagents. The resultant B-side stream 18 exiting in-line continuous mixer 16 is fed through heat exchanger 20 and then through precision metering pump 22 to contact an A-side stream 24 of polyurethane reagents at dispensing head 26. Dispensing head 26 mixes the A-side and B-side streams 24, 18 and dispenses them into a laminator 28, where the dispensed mixture reacts and is expanded via blowing agents 14 to provide the desired polyurethane or polyisocyanurate foam.

Polyol mixture 12 contains polyol component and optional components as mentioned above. The various components of polyol mixture 12 may be mixed by conventional methods (not shown). Polyol mixture 12 is generally maintained at a temperature of about 10° C. to about 35° C. and a pressure of less than about 3400 kPa as it is advanced toward the in-line continuous mixer 16. Preferably, polyol mixture 12 is maintained at about 15° C. to about 25° C. and about 100 kPa to about 860 kPa. More preferably, polyol mixture 12 is advanced a pressure less than at about 500 kPa.

The types and amount of optional components in polyol mixture 12 that may be useful in the production of a desired foam are well known in the art. Generally, the amount of catalyst present in polyol mixture 12 will range from about 0.1 to about 10.0 pphp (parts per hundred polyol). The amount of flame-retardants will range from about 0 to about 25 pphp. The amount of water will range from about 0.1 to about 2.0 pphp.

In the present process, blowing agent 14 is mixed with polyol mixture 12 in such a manner that a lesser amount of surfactants and/or emulsifiers/solubilizers will typically be required in polyol mixture 12, if at all. Although some amount of surfactant is needed for cell nucleation and cell stabilization, emulsifiers, solubilizers, and surfactants tend to plasticize the foam produced, which reduces the compressive strength and dimensional stability of the foam. Various types of blowing agents may be mixed with polyol mixture 12, in varying ratios, and still yield an emulsification, with either a lesser amount or no emulsifiers/solubilizers, and the minimal amount of surfactants. Some blowing agents, such as isopentane, may not be very soluble with the other B-side components and, therefore, require emulsifiers/solubilizers and/or increased levels of surfactants to make high quality foams.

As mentioned, prior art processes may require surfactants in an amount from about 0.5 to about 5.0 pphp and emulsifiers/solubilizers in an amount from about 0 to about 30 pphp. Practicing the process of the present invention may, in comparison, require surfactants in an amount from about 0.5 to about 3.0 pphp and emulsifiers/solubilizers in an amount from about 0 to about 5.0 pphp. Surfactants, solubilizers, and emulsifiers tend to plasticize the foam produced and, therefore, reduced amounts of these components in the foam formulation is desirable.

The flow rate of the polyol mixture may be varied according to the desired mix ratio of the polyol mixture to the blowing agents. More particularly, the mix ratio will be based upon the desired ratio of polyol components to blowing agent as is known in the art.

Blowing agent 14 is advanced and fed to in-line continuous mixer 16 at a temperature of from about 10° C. to about 35° C. and a pressure of less than about 3400 kPa. Preferably, blowing agent 14 is maintained at about 15° C. to about 25° C. and about 100 kPa to about 860 kPa. More preferably, blowing agent 14 is advanced at a pressure less than about 500 kPa. The flow rate of blowing agent 14 is adjusted to achieve different desired ratios of blowing agent to polyol component within the B-side stream 18 of polyurethane reagents that is created at in-line continuous mixer 16.

Blowing agent 14 may be provided as a mixture of blowing agents. If a mixture of blowing agents is desirable, the various blowing agents within blowing agent 14 may be mixed by conventional methods. Optionally, in order to allow for accurate measurement of the amount of each blowing agent added, each i blowing agent is added to in-line continuous mixer 16 as a separate stream.

Blowing agent 14 is advanced through heat exchanger 30 to low-pressure pump 32 . Low-pressure pump 32 pumps blowing agent 14 through flow meter 34 toward three-way valve 36. Three-way valve 36 may be operated to either allow blowing agent 14 to advance toward in-line continuous mixer 16 or to direct blowing agent 14 through a recycle line indicated at numeral 38, which reconnects to the system at a position before heat exchanger 30. If blowing agent 14 is being recycled through this closed loop, check valve 40 is closed. Heat exchanger 30 is employed to prevent the buildup of heat within the stream of blowing agents 14 during recycling.

Three-way valve 36 is operated to force blowing agent 14 through recycle line 38 whenever a foam board is not being produced. When a foam board is to be produced, three-way valve 36 is opened to allow blowing agent 14 to advance through line 39 toward in-line continuous mixer 16.

Flow meter 34 measures the mass flow rate of blowing agent 14 . This mass flow rate will be directly related to the ratio of blowing agent 14 within B-side stream 18 and, thus, measurement of the mass flow rate, via flow meter 34, allows for adjustment of the amount of blowing agent 14 within the B-side stream 18. This will be described more fully hereinbelow.

The ratio of polyol components to blowing agents to be mixed in in-line continuous mixer 16 will depend upon the desired properties of the foam to be produced. Generally, when greater amounts of blowing agents are employed, the foam produced will be lower in density, while, when lesser amounts of blowing agents are employed, the foam produced will be higher in density. Those of ordinary skill in the art will appreciate what types and amounts of blowing agents are useful in the production of a desired foam product. The blowing agent to polyol component mass ratio will preferably range from 1:10 to 1:4, more preferably, from 1:7 to 1:5.

Blowing agent 14 is typically introduced to in-line continuous mixer 16 as a liquid. The preferred blowing agents include at least one pentane isomer and, optionally, may contain auxiliary blowing agents as defined above. Notably, auxiliary blowing agents are typically added to in-line continuous mixer 16 as a separate stream from the pentane isomer. A particularly useful auxiliary blowing agent is carbon dioxide (CO₂). By adding CO₂ as an auxiliary blowing agent, the amount of water present in the polyol mixture may be decreased. Water is usually added because it forms CO₂ through reaction with the other foam forming reagents, thus, the addition of CO₂ as an auxiliary blowing agent decreases the need for water, decrease production costs.

Polyol mixture 12 and blowing agent 14 are contacted and mixed within in-line continuous mixer 16. An “in-line continuous mixer” refers to a mixer that allows for the continuous introduction and removal of components therefrom so as to realize no substantial net gain or loss of volume within the mixer. That is, the volumetric flow rate of components entering the in-line continuous mixer is substantially equal to the volumetric flow rate of the mixture exiting the in-line continuous mixer. “In-line continuous mixers” to preferably emulsify and blend polyol mixture 12 and the blowing agent 14 . Additionally, during production of a foam board, in-line continuous mixer 16 does not serve as a general supply tank for B-side stream 18, but rather continuously creates B-side stream 18 from polyol mixture 12 and blowing agent 14 as they are advanced through the process. These mixers are distinguishable from batch mixers.

In-line continuous mixer 16 is preferably employed to mix polyol mixture 12 and blowing agent 14 at the low-pressure side of the process, i.e., before precision metering pump 22. Employment of in-line continuous mixer 16 on the low-pressure side allows for easier adjustment in the ratios and amounts of blowing agents used in relation to the ingredients within the polyol mixture stream 12. In-line continuous mixer 16 may be employed on the high-pressure side, but this is not preferred. It has been found that good mixing and accurate mix ratios are more difficult and less precise in high-pressure mixing operations, and, additionally, mixers in high-pressure systems must be more structurally sound and are thus more expensive. By using an in-line continuous mixer 16, and employing this mixture on the low-pressure side of the system, the mix ratios of the ingredients can be easily adjusted, through the use of flow meters, in a continuous process.

Suitable in-line continuous mixers include dynamic mixers. Generally, dynamic mixers employ moving blades or impellers to impart motion to the fluids within the mixer and thereby produce the mixing effect. Useful dynamic mixers include pin-impeller mixers, turbine mixers, double helix mixers, and radial axial mixers. Suitable in-line continuous mixers also include static mixers. Generally, static mixers consist of a pipe containing a series of specially shaped stationary blades, which divide and twist the flowing stream of fluid within the pipe so that mixing proceeds by a distributive process.

Preferably, the volume of the in-line continuous mixer 16 is from about 1 liter to about 40 liters. More preferably, the volume of the in-line continuous mixture is generally from about 3.5 liters to about 7.5 liters. In-line continuous mixer 16 is of relatively small volume as compared to apparatus used in the prior art for mixing blowing agents with polyol components. The small volume of in-line continuous mixer 16 is beneficial because, as will be described below, when flammable blowing agents such as pentane isomers are employed, in-line continuous mixer 16 may be enclosed within a ventilation system that exhausts any flammable blowing agent that escapes from the system.

The use of an in-line continuous mixer provides advantages in a polyurethane or a polyisocyanurate foam board production process. Particularly, the flow rate of the polyol mixture and blowing mixtures may be varied according to the desired mix ratio of the polyol mixture to the blowing agents. Also, with proper mixing, the amount of surfactants, emulsifiers, and solubilizers required to assure adequate mixing of blowing agents, particularly pentane isomers, with the polyol mixture can be reduced. Additional safety features can also be added to the process due to the fact the in-line continuous mixer is relatively smaller than the mixing apparatus of the prior art, and the in-line continuous mixer can be enclosed in a ventilation system.

Adequate mixing of the polyol mixture with the blowing agents, i.e., mixing that deters phase separation, can be empirically determined through experimental runs without undue experimentation. Notably, for achieving desired foam board properties, the empirical method will be appreciated by those of ordinary skill in the art.

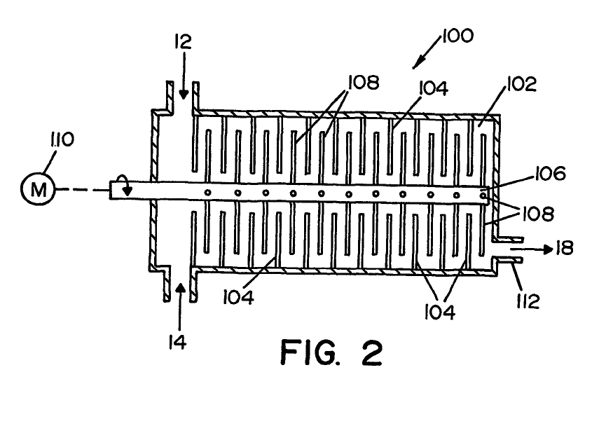

A particularly useful in-line continuous mixer is a dynamic pin-impeller mixer. A cross-sectional view of a pin-impeller mixer that may be employed for in-line continuous mixer 16, is provided in FIG. 2, and designated generally by the numeral 100. Pin-impeller mixer 100 includes a chamber 102 to which polyol mixture 12 and blowing agent 14 are introduced. Chamber 102 includes pin protrusions 104, which extend inwardly from its outer walls, and impeller 106 having pin protrusions 108 that extend outwardly from impeller 106 between pin protrusions 104 . A motor 110 is operatively connected to impeller 106, and serves to rotate impeller 106. Polyol mixture streams 12, and blowing agent 14 added to chamber 102 are subjected to high amounts of shear by the rotation of motor 110 and, as a result, blowing agent 14 is mixed with polyol mixture 12 to a greater extent than heretofore realized in the art.

Pin-impeller mixer 100 preferably has a volume of from about liters to about 40 liters, and, more particularly, from about 3.5 to about 7.5 liters. The contents of the pin-impeller mixer 100, i.e., blowing agent 14 and polyol mixture 12 are preferably kept at a temperature of from about 10° C. to about 35° C., and, more preferably, from about 15° C. to about 25° C. Motor 110 rotates impeller 106 at a speed of about 500 to about 3,600 revolutions per minute (rpm), and, more preferably, at a speed of about 1,000 to about 2,500 rpm.

The mixing that occurs in in-line continuous mixer 16 may alternatively be carried out in multiple in-line continuous mixers. That is, polyol mixture 12 and blowing agent 14 may be first introduced to in-line continuous mixer 16 and mixed therein, and, thereafter, may be advanced to a second in-line continuous mixer (not shown). Third and fourth in-line continuous mixers may also be employed. Multiple in-line continuous mixers may be arranged in series and serve to increase the effectiveness of the mixing function. After mixing, whether in a single or multiple in-line continuous mixers, the resultant B-side stream 18 is quickly advanced to and dispensed from dispensing head 26 along with A-side stream 24. Particularly, the residence time of B-side stream 18, from its exit from in-line continuous mixer 16 to its exit from dispensing head 26, is less than about 1.5 minutes. This will be disclosed more fully below.

Polyol mixture 12 and blowing agent 14, when mixed by impeller mixer 100, provide the B-side stream 18. B-side stream 18 exits pin-impeller mixer 100 at outlet 112. B-side stream 18 exits at a flow rate that is dependant upon the entering flow rates of polyol mixture 12 and blowing agent 14 . As mentioned, the flow rates of polyol mixture 12 and blowing agent 14 depend upon the desired ratio of blowing agent to polyol component.

During foam board production, in-line continuous mixer 16 constantly receives polyol mixture 12 and blowing agent 14 and mixes them to form B-side stream 18 and constantly advances this B-side stream to the high-pressure side of the system. Referring now back to FIG. 1, the B-side stream 18 exits in-line continuous mixer 16 and is fed to heat exchanger 20. Heat exchanger 20 preferably has a volume of from about 7.5 liters to about 75 liters, and, more preferably, from about 7.5 to about 20 liters.

From heat exchanger 20, B-side stream 18 is fed to precision metering pump 22. Precision metering pump 22 advances B-side stream 18 through flow meter 42, and thereafter through three-way valve 44. As shown in FIG. 1, three-way valve 44 may be operated to allow B-side stream 18 to advance to dispensing head 26 or, in the alternative, may be operated to force B-side stream 18 back to in-line continuous mixer 16 through a recycle line indicated at numeral 46. As with three-way valve 36, the direction that B-side stream takes through three-way valve 44, whether for advancement of B-side stream 18 to dispensing head 26 or for the recycling thereof to in-line continuous mixer 16, depends upon whether or not a foam board is being produced. When a board is being produced, B-side stream 18 is directed toward dispensing head 26. When a board is not being produced, B-side stream 18 is directed through recycle line 46.

Precision metering pump 22 operates to advance B-side stream 18 at a set flow rate regardless of the backpressure within the system. Thus, when three-way valve 44 is open so as to permit B-side stream to advance towards dispensing head 26, B-side stream 18 advances at a pressure of between about 6,800 kPa to about 20,000 kPa, and, more preferably, at a pressure between about 13,500 kPa to about 17,000 kPa. This large pressure is due to the amount of backpressure encountered in bringing A-side stream 24 and B-side stream 18 together at dispensing head 26 and dispensing them into laminator 28. Despite this backpressure, precision metering pump 22 advances B-side stream at a constant flow rate and therefore the pressure increase is realized. The B-side is said to be advanced through the high-pressure side of the system. When three-way valve 44 is open so as to force B-side stream to recycle, precision metering pump 22 feeds B-side stream 18 at the same set flow rate; however, there is little back pressure, and B-side stream recycles at low-pressure, at from about 100 kPa to about 3400 kPa.

Flow meter 42, together with flow meter 34, facilitates the adjustment of the mix ratio of the blowing agent within the B-side stream. Particularly, flow meter 42 measures the mass flow rate of the B-side stream 18 flowing therethrough, and, based upon the mass flow rate across flow meter 42, the flow rate of blowing agent 14 across flow meter 34 can be adjusted accordingly to provide the desired end ratio of blowing agent within the B-side stream.

In an alternative embodiment, B-side stream 18 is split into multiple streams after exiting heat exchanger 20. Each stream includes a precision metering pump, flow meter, three-way check valve, and recycle line as described above. The various recycle lines would preferably join together before being introduced back into the in-line continuous mixer as one stream. In such an embodiment, the A-side stream 24 would also be split into an equal number of streams such that each separate B-side stream, when advanced at high-pressure toward contact with an associated A-side stream, would advance to a separate dispensing head. This embodiment is useful when, due to the dimensions of the laminator, multiple dispensing heads must be used to fill the laminator.

When the blowing agents employed are flammable blowing agents, such as pentane isomers, in-line continuous mixer 16 is preferably enclosed by a ventilation system, generally represented in FIG. 1 by the numeral 50. Ventilation system 50 serves to collect any flammable blowing agent that may escape from the system so as to minimize any safety concerns. As can be seen, ventilation system 50 includes an enclosure 52, generally represented by the dashed lines in FIG. 1. Enclosure 52 completely encloses the majority of the process components that contain the flammable blowing agents, although the blowing agents are initially introduced from a position outside enclosure 52, and B-side stream 18, which contains the flammable blowing agents, ultimately exits enclosure 52 to advance to dispensing head 26. Enclosure 52 is air tight and preferably explosion proof for added safety. One or more exhaust fans 54 communicate with the interior of enclosure 52 and are connected to exhaust duct 56. Fans 54 and duct 56 serve to collect and remove any flammable blowing agents that may escape from the system and into enclosure 52.

Notably, in-line continuous mixer 16 is of much smaller volume that the tanks and other apparatus of the prior art used for incorporating blowing agents into a polyol mixture. Therefore, the use of a ventilation system 50 is very practical, because it will not have to be of a large size. The present apparatus and process is safer than prior art processes in that the amount of flammable blowing agent present in a B-side stream of polyurethane reagents at any given time is much smaller than the amount generally present in prior art processes.

A-side stream 24 is fed through a heat exchanger 58 to high-pressure pump 60. High-pressure pump 60 advances A-side stream 24 through flow meter 62, and thereafter through three-way valve 64. As can be seen in FIG. 1, three-way valve 64 may be operated to allow A-side stream 24 to advance to dispensing head 26 or, in the alternative, may be operated to force A-side stream 24 back to a position before heat exchanger 58 through a recycle line indicated at numeral 66. As with three-way valve 36, the operation of three-way valve 64, whether for advancement of A-side stream 24 to dispensing head 26 or for the recycling thereof, depends upon whether or not a foam board is being produced. When a board is being produced, three-way valve 64 is opened to allow A-side stream 24 to advance to dispensing head 26. When a board is not being produced, three-way valve is opened to force A-side stream 24 through recycle line 66.

When producing board, A-side stream 24 of polyurethane reagents is advanced through high-pressure pump 60 and flow meter 62, and brought into contact with B-side stream 18 on the high-pressure side of the process at dispersing head 26. A-side stream 24 is preferably maintained at a temperature of from about 15° C. to about 45° C. and a pressure from about 6,800 kPa to about 20,000 kPa. Mare particularly, the temperature is maintained at about 25° C. to about 40° C. and a pressure from about 13,500 kPa to about 17,000 kpa. The flow rate for A-side stream 24 is chosen based upon the desired ratio of polyol components to isocyanate in the end product dispensed to the laminator. As mentioned with respect to the amounts of blowing agent and polyol components employed, the ratio of polyol components in the B-side to isocyanate components within the A-side will depend upon the desired properties of the foam to be produced.

The ratio of the equivalence of NCO groups (provided by the isocyanate or “A-side”) to all polyol components is called the index. When the NCO equivalence to the polyol equivalence is equal, then the index is 1.00 or 100, and the mixture is said to be stoiciometrically equal. As the ratio of NCO equivalence to polyol equivalence increases, the index increases. Above an index of about 150 the material is generally known as a polyisocyanurate foam, even though there are still many polyurethane linkages. When the index is below about 150, the foam is generally known as a polyurethane foam even though there may be some isocyanurate linkages.

An isocyanurate is a trimeric reaction product of three isocyanates forming a six-membered ring. Isocyanurates are characterized by their good thermostability and excellent dimensional stability. However, they also tend to be friable when used at high indexes, hence index ratios of 200 to 350 are preferred for isocyanurate foams.

A-side stream 24 is brought into contact with B-side stream 18 at dispensing head 26. Dispensing head 26 is typically an impingement mixer, wherein A-side stream 24 and B-side stream 18 forcefully contact one another, at high-pressure, and are thereafter dispensed from dispensing head 26 and into laminator 28. At laminator 28, the foam formulation of the various components of A-side stream 24 and B-side stream 18 interact to produce a foam board as commonly known in the art.

As mentioned, A-side stream may be split into multiple streams when multiple dispensing heads are necessary. The A-side stream is split before the high-pressure pump, and each separate A-side stream has its own high-pressure pump, flow meter, check valve and recycle line, and each A-side stream advances towards contact with an associated B-side stream at an associated dispensing head.

To ensure that the blowing agents do not phase separate from the other components within the B-side stream, and more particularly, from the polyol components within the B-side stream, the residence time of the B-side stream, from its exit from the in-line continuous mixer to its impingement with the A-side stream at the dispensing head, is preferably controlled. Particularly, the residence time of the B-side stream within the process is preferably less than 5 minutes from its exit from the in-line continuous mixer to its introduction to the laminator. In other words, the residence time of the B-side stream of polyurethane reagents, from it exit from the in-line continuous mixer to its exit from the dispensing head as part of a foam formulation is preferably less than 5 minutes. More preferably, this residence time is less than 1.5, even more preferably less than 60 seconds, and even more preferably less than 30 seconds.

In order to demonstrate the practice of the present invention, the following examples have been prepared and tested. The examples should not, however, be viewed as limiting the scope of the invention. The claims will serve to define the invention.

### EXAMPLES

### Example 1

Formulation

| Polyol Mixture | |
|---|---|
| Stepan Polyol 2352 (pbw) | 100 |
| Pelron Catalyst 9540A (Potassium Octoate) (pbw) | 4.4 |
| Pelron Amine Catalyst 9529 (pbw) | 0.55 |
| Goldschmidt Surfactant B8469 (pbw) | 3 |
| Rhodia Flame Retardant AB 80 (FBP) (pbw) | 12.5 |
| Water (pbw) | 0.5 |
| Blowing Agent | |
| Exxsol Pentane Blend 1600 (pbw) | 25.4 |
| A-Side | |
| Total Huntsman Polyurethanes Rubinate 1850 (pbw) | 212.08 |
| Index | 300 |
| A/B ratio | 1.45 |
| Processing Variables | |
| No. mixheads | 2 |
| Top laminator temperature (° F.) | 140 |
| Bottom laminator temperature (° F.) | 133 |
| A-Side temperature (° F.) | 88 |
| B-side temperature (° F.) | 82 |
| Line speed (ft./min.) | 93.2 |
| A-Side pressure (psi) | 2000 |
| B-Side pressure, high-pressure side (psi) | 1737 |
| B-Side, low-pressure side (psi) | 60 (approx) |
| A-Side per mixhead (lbs./min) | 26.1 |
| B-Side per mixhead (lbs./min) | 18.2 |
| In-line mixer setting | 50% |
| rpms | 1830 |
| Machine Reactivity | |
| Cream time (sec) | 5 |
| Gel time (sec) | 13 |
| Tack free time (sec) | 37 |
| End of rise time (sec) | 58 |
| Physical Propertied of Board | |
| Board Thickness (inches) | 1.50 |
| Core density (pcf) | 1.69 |
| Initial k-factor (Bru in./h ft² ° F.) | 0.14 |
| Compressive Strength (psi) | 23.2 |
| Huntsman Dimvac test at −25° C. (14 days) | |
| Width | −0.5 |
| Length | −0.3 |
| Closed cell content (%) | 90.9 |
| Average cell size, μm | n/a |
| Butler Chimney test weight retained (%) | 90.3-91.4 |

### Example 2

Formulation

| Polyol Mixture | |
|---|---|
| Stepan Polyol 2352 (pbw) | 100 |
| Pelron Catalyst 9540A (Potassium Octoate) (pbw) | 4.6 |
| Pelron Amine Catalyst 9529 (pbw) | 0.55 |
| Goldschmidt Surfactant B8469 (pbw) | 3 |
| Rhodia Flame Retardant AB 80 (FBP) (pbw) | 12.5 |
| Water (pbw) | 0.5 |
| Blowing Agent | |
| Phillips Petroleum Isopentane | 25.1 |
| A-Side | |
| Total Huntsman Polyurethanes Rubinate 1850 (pbw) | 206.2 |
| Index | 300 |
| A/B ratio | 1.41 |
| Processing Variables | |
| No. mixheads | 3 |
| Top laminator temperature (° F.) | 145 |
| Bottom laminator temperature (° F.) | 153 |
| A-Side temperature (° F.) | 89 |
| B-side temperature (° F.) | 75 |
| Line speed (ft./min.) | 89.4 |
| A-Side pressure (psi) | 2217 |
| B-Side pressure, high-pressure side (psi) | 2164 |
| B-Side pressure, high-pressure side (psi) | 60 (approx.) |
| A-Side per mixhead (lbs./min) | 22.8 |
| B-Side per mixhead (lbs./min) | 16.1 |
| In-line mixer setting | 25% |
| rpms | 925 |
| Machine Reactivity | |
| Cream time (sec) | 0 |
| Gel time (sec) | 14 |
| Tack free time (sec) | 24 |
| End of rise time (sec) | n/a |
| Physical Properties of Board | |
| Board Thickness (inches) | 2.10 |
| Core density (pcf) | 1.68 |
| Initial k-factor (Bru in./h ft² ° F.) | 0.149 |
| Compressive Strength (psi) | 18.8 |
| Huntsman Dimvac test at −25° C. (14 days) | |
| Width | −1.0 |
| Length | −0.3 |
| Closed cell content (%) | 90.9 |
| Average cell size, μm | 0.16-0.19 |
| Butler Chimney test weight retained (%) | 90.3-91.4 |

In Example 1 the pentane blend used was Exxsol 1600, which is approximately 70% cyclopentane and 30% isopentane. This blend is relatively soluble in the B-side. B-sides blends made with Exxsol 1600 can be processed in a number of methods including the method described in this invention. However, there are a number of combinations of polyol type, flame-retardants, level of Exxsol 1600 and processing temperatures that could increase the probability of phase separation or large cell structure in the foam. The advantage of the method described in this invention is that, as compared to other methods, it is much less likely to either result in phase separation or yield large cells.

The foams board produced in Example 1 had excellent strength (compressive strength: 23.2 psi), low thermal conductivity (0.14 Btu-in./hft²° F.), and was dimensionally stable as measured by the Huntsman Dimvac test in the two critical directions. In the Dimvac test the foam sample was put into a vacuum to remove any carbon dioxide formed primarily from the reaction of water with isocyanate. This reduced the cell pressure and made it more susceptible to cold age shrinkage. The sample was then put in the freezer at−25° C. for 14 days and then dimensional changes were measured. This test reproduced unrealistic conditions for the board, such that, if a board passes this test, the board manufacturer can be confident that it will perform in the field. It has been determined that if a linear change in this test on small samples is less than −5%, then the board will be dimensionally stable in the field. The percent linear change in the length and width were well below −1.0%. thus excellent boards were made from Example 1.

Isopentane is not very soluble in the B-side and will phase separate much more readily. Additionally, the use of isopentane will produce a thick emulsion, which requires efficient mixing in a timely manner. Isopentane will phase separate or produce large cells unless emulsifiers are used in many processing methods. For example, in a batch process it would require a long time with vigorous mixing to obtain an emulsion and, over a short period of time, the isopentane would start to phase separate. The process described in this invention circumvents these problems.

Example 2 illustrates that, even in this highly stressed formulation, with isopentane, the method described in this invention mixed the blowing agents very well and produced a high quality foam. The foam was strong with a low thermal conductivity and was dimensionally stable. The small cell size confirmed that the isopentane was well mixed. Isopentane requires a lot of energy to mix thoroughly with the polyol mixture and then stay in an emulsion long enough to make excellent foam. The method described in this invention facilitates the mixing of isopentane with the polyol mixture and doesn't allow the components to phase separate.

It is important to note the high output of the A-side and B-side and the large amount of pentane blowing agent used in both examples. The higher the output the more stress is put on the method to efficiently mix the pentane blowing agent with the polyol mixture and the higher the pentane blowing agent level in the B-side the harder it is to keep in solution. This further demonstrates the wise utility of the method in this invention.

Thus, it should be appreciated that the present disclosure provides advancements in the art of polyurethane and polyisocyanurate foam board production. Various modifications and alterations that do not depart from the scope and spirit of this invention will become apparent to those skilled in the art. This invention is not to be duly limited to the illustrative embodiments set forth herein. The claims will serve to define the proper scope of the invention.

What is claimed is:

1. A method for manufacturing polyurethane and polyisocyanurate foams comprising the steps of:
charging at least one blowing agent and a polyol component to an in-line continuous mixer at a pressure of less than about 3,400 kPa, wherein the at least one blowing agent and the polyol component are continuously charged in separate streams advanced at predetermined flow rates chosen to bring about a desired ratio of blowing agent to polyol component within the in-line continuous mixer;
mixing the at least one blowing agent and the polyol component in the in-line continuous mixer to dissolve or emulsify the blowing agent in the polyol component and thereby provide a B-side stream of polyurethane reagents;
contacting the B-side stream of polyurethane reagents with an isocyanate component at a dispensing head to provide a foam formulation; and
dispensing the foam formulation from the dispensing head, wherein the residence time of the B-side stream of polyurethane reagents, from its exit from the in-line continuous mixer to its exit from the dispensing head as part of the foam formulation, is less than about 5 minutes.

2. A method for manufacturing polyurethane and polyisocyanurate foams comprising the steps of:
charging at least one blowing agent and a polyol component to an in-line continuous mixer, wherein the at least one blowing agent and the polyol component are continuously charged in separate streams advanced at predetermined flow rates chosen to bring about a desired ratio of blowing agent to polyol component within the in-line continuous mixer.

3. A method for manufacturing polyurethane and polyisocyanurate foams comprising the steps of:
charging at least one blowing agent and a polyol component to an in-line continuous mixer, at a pressure of less than about 3,400 kPa, to form a B-side stream of polyurethane reagents;
contacting the B-side stream of polyurethane reagents with an isocyanate component at a dispensing head to provide a foam formulation; and
dispensing the foam formulation from the dispensing head, wherein the residence time of the B-side stream of polyurethane reagents, from its exit from the in-line continuous mixer to its exit from the dispensing head as part of the foam formulation, is less than about 5 minutes.

4. The method of claim 2, further comprising the steps of mixing the at least one blowing agent and the polyol component in the in-line continuous mixer to dissolve or emulsify the blowing agent in the polyol component and thereby provide a B-side stream of polyurethane reagents;
contacting the B-side stream of polyurethane reagents with an isocyanate component at a dispensing head to provide a foam formulation; and
dispensing the foam formulation from the dispensing head.

5. The method of claim 1, 2 , or 3, wherein the in-line continuous mixer is selected form the group consisting of dynamic mixer and static mixers.

6. The method of claim 5, wherein the in-line continuous mixer is a dynamic mixer selected from the group consisting of pin-impeller mixers, turbine mixers, double helix mixers, and radial axial mixers.

7. The method of claim 1, 2, 3, 5, or 6, where in volume of the in-line continuous mixer is from about 1 to about 40 liters.

8. The method of claim 1, 3, or 4, wherein the residence time of the B-side stream, from its exit from the in-line continuous mixer to its exit from the dispensing head as part of the foam formulation, is less than about one minute.

9. The method of claim 8, wherein the residence time of the B-side stream, from its exit from the in-line continuous mixer to its exit from the dispensing head as part of the foam formulation, is less than about thirty seconds.

10. The method of claim 1, 2, or 3, wherein, in said step of charging the at least one blowing agent and the polyol component to the in-line continuous mixer occurs at a pressure of less than about 500 kPa.
